(19) United States
(12) Patent Application Publication
(10) Pub. No.: US 2005/0191606 A1
(43) Pub. Date: Sep. 1, 2005

(54) Method for educational development

(76) Inventor: Joseph Heighton Semadeni, Fairview, WY (US)

Correspondence Address: KUNZLER & ASSOCIATES, 8 EAST BROADWAY, SALT LAKE CITY, UT, 84111, US

(21) Appl. No.: 11/068,247

(22) Filed: Feb. 28, 2005

Related U.S. Application Data
(60) Provisional application No. 60/548,551, filed on Feb. 27, 2004.

(51) Int. Cl. G09B 19/00

(52) U.S. Cl. 434/219

(57) ABSTRACT

A method for educational development includes implementing a motivational program that provides incentive for an adult to pursue skills mastery within a chosen discipline, defining an education facilitator that assists an adult in pursuing skills mastery within a chosen discipline, and defining a flexible time schedule that enables an adult to pursue skills mastery within a chosen discipline. Adults may choose to participate in an organized motivational program that encourages individual development and professional collaboration.

### CROSS-REFERENCES TO RELATED APPLICATIONS

This application claims priority to U.S. Provisional Patent Application No. 60/548,551 entitled “METHOD FOR EDUCATIONAL DEVELOPMENT” and filed on Feb. 27, 2004 for Joseph Semadeni, which is incorporated herein by reference.

### BACKGROUND OF THE INVENTION

1. Field of the Invention

This invention relates to professional development and more particularly relates to methods for furthering adult educational development.

2. Description of the Related Art

Public education is necessary to preserve our civilization and to educate our children. The current education system, however, suffers from various ailments that prevent our society from rising above mediocrity. Government-funded education is available to our youth. But once an individual reaches adulthood, relatively no adult education system exists to support adults as they mature, develop and function within a chosen discipline. Adults may receive some initial training, but are typically left alone to work out any problems or deficiencies they may have, isolated from other professionals. As a result, adults often struggle to progress. They may even become overwhelmed and depressed, failing to find value in their daily activities. Particularly within our education system, discouraged adults negatively affect our tender youth, the quality of their education, and hence, the future of our society.

Currently, the public education system focuses on student achievement. Government educational programs are created, setting achievement standards for young students. If the students do not achieve the set standards, however, the results often reflect negatively on the teachers, whose jobs may be at risk. This form of evaluation places undue pressure on the teachers, who tend to feel frustrated by the system and unfulfilled in their profession. Unfortunately, teachers often focus more effort on drilling students to pass the standardized tests than developing effective teaching skills or inspiring life-long learning habits in the students. As a result, both the teachers and the students have an unpleasant experience in the public education system, and any positive results are relatively short-lived.

Also, the government programs typically offer no incentive for teachers to progress or excel within their discipline. Teachers are pressured and overloaded, without receiving recognition or additional benefits. Often work schedules do not allocate time for skills improvement. If teachers want to continue to study, they must do so outside of school, which infringes on personal time, and with their own resources, which may dissuade many from seeking additional education or training. Generally, teachers maintain a classroom isolated from other teachers who may have more expertise. Consequently, teachers typically progress slowly as professionals, because their knowledge is usually limited to their own experiences in a classroom.

Furthermore, teachers usually do not feel secure to talk to a principal or administrator to resolve their problems or personal concerns, because the administrators have the power to hire or fire an individual. Admitting weakness could put a teacher's job on the line. Traditionally, administrators offer some form of professional training, such as workshops, but the material is generally not personalized enough to truly benefit the teachers. Besides the teachers may feel a lack of support to implement new practices. Consequently, teachers may leave such workshops feeling they have wasted their time, or feeling overwhelmed and thus continue teaching in their regular fashion without improvement.

Adults in other professions or disciplines face similar challenges. They may feel overloaded, isolated, and threatened with negative consequences in order to produce a desired result. In addition, they may lack adequate recognition, continual training and support, and the personal satisfaction necessary to move them to improve their skills and to inspire growth in others.

From the foregoing discussion, it should be apparent that a need exists for a method to educate adults that focuses on known principles of adult learning and adult motivation. Beneficially, such a method would provide incentive for adults to excel in a chosen discipline. In addition, the method would support adults in their efforts to progress and would provide a scheduled time for adults to pursue skills mastery within a regular schedule. Furthermore, the method would facilitate collaboration among adults to encourage peer observation, problem solving, and personal growth.

### SUMMARY OF THE INVENTION

The present invention has been developed in response to the present state of the art, and in particular, in response to the problems and needs in the art that have not yet been fully solved by currently available methods for professional development. Accordingly, the present invention has been developed to provide a method for educational development that overcomes many or all of the above-discussed shortcomings in the art.

A method of the present invention is presented for encouraging educational development and growth within a chosen discipline. In one embodiment, the method includes implementing a motivational program that provides incentive for an adult to pursue skills mastery within a chosen discipline, defining an education facilitator that assists an adult in pursuing skills mastery within a chosen discipline, and defining a flexible time schedule that enables an adult to pursue skills mastery within a chosen discipline. The method provides opportunities to adults to enable them to master skills required to excel within a professional discipline. Adults may choose to participate in an organized motivational program that encourages individual development and professional collaboration.

In a further embodiment, the method includes developing one or more professional learning communities within a chosen discipline, assessing a formative path for growth within a chosen discipline, developing content to sustain growth within a chosen discipline, and evaluating progress and determining needed changes for continual growth. In a further embodiment, the method additionally includes producing resource material relative to a chosen discipline to sustain growth within the discipline. Consequently, adults feel supported and motivated to achieve greater levels of personal satisfaction and self-actualization. In addition, adults are able to make positive contributions to society as a whole.

The method may be implemented in any communal environment where various adults interact. In one embodiment, the method is designed to encourage educators within a school system to progress as professionals and to make a greater impact on students. In certain embodiments, the motivational program may be integrated with a traditional pay scale. Furthermore, growth and progress may be tracked on a computer or with a computer program.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention supports educational development and provides incentive for skills mastery. A motivational program of the present invention encourages an adult to continue learning new skills and to excel within a defined discipline. An education facilitator may assist an adult in pursuing skills mastery and may administrate the motivational program. Additionally, a defined time schedule preferably permits an adult to pursue skills mastery within a working schedule. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is block diagram illustrating a hierarchy of proposed stages for implementing an adult educational development method according to one embodiment of the present invention;

FIG. 2 is a block diagram illustrating a proposed overview of an educational development method according to one embodiment of the present invention;

FIG. 3 is a Venn diagram illustrating components of an educational development method according to one embodiment of the present invention;

FIG. 4 is a Venn diagram illustrating FIG. 3 in greater detail;

FIG. 5 is a table illustrating one embodiment of effective instructional practices grouped into categories and subcategories according to one embodiment of the present invention;

FIG. 6 is a table illustrating one embodiment of a traditional pay scale for educators with pay increases awarded for skills mastery in accordance with the present invention; and

FIG. 7 is a schematic flow chart diagram illustrating one embodiment of an educational development method of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention is based on research defining principles of adult motivation and adult learning. According to Abraham Maslow, a renowned psychologist, every individual has a hierarchy of needs that motivate them to act. Basic needs for physical nourishment and emotional security must be met before an individual is motivated to achieve greater accomplishments. Our highest human needs include desires for personal development and self-actualization. The present invention addresses these fundamental needs by providing a method to help adults continue to advance developmentally.

Similarly, researchers of adult learning have determined that adults continue to increase in intelligence in certain areas such as judgment, knowledge, and experience as they age. Adults have a need to solve real-life problems related to adult developmental tasks. Accordingly, the present invention encourages adults to exercise good judgment as they choose to excel in a defined discipline. The opportunity to choose one's course of action is a key principle to adult learning and individual progress and may be incorporated into the educational development method of the present invention.

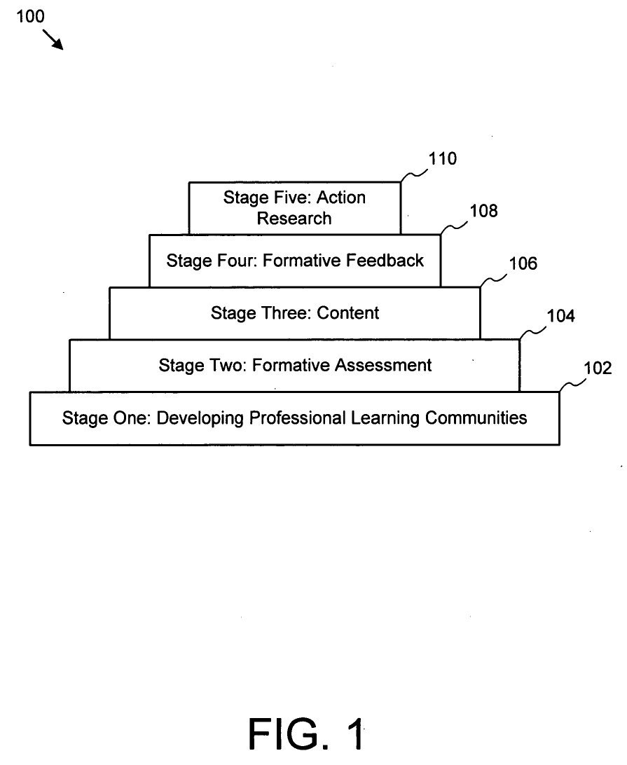

FIG. 1 illustrates a hierarchy 100 of proposed stages for implementing an adult educational development method according to one embodiment of the present invention. The hierarchy 100, as depicted, includes stage one 102 for developing one or more professional learning communities within a chosen discipline, stage two 104 for assessing a formative path for growth within a chosen discipline, stage three 106 for developing content to sustain growth within a chosen discipline, stage four 108 for evaluating progress and determining needed changes for continual growth, and stage five 110 for producing resource material, such as action research, to sustain growth within a chosen discipline.

In one embodiment, implementation of the educational development method of the present invention is divided into five stages 100 to enable gradual growth and acceptance of the key principles of the method. The five stages 100 may be spread out over a defined period of time. Each stage preferably prepares an adult or an organization to advance from one developmental stage to another, the lower stages being satisfied before the higher stages. In a preferred embodiment, the developmental stages 100 advance as characteristics, skills, and attitudes develop in accordance with a desired result and are not forced to conform to a rigid time schedule. Consequently, significant results may be achieved.

At Stage One 102, professional learning communities may be developed. Professional learning communities prevent adults from feeling isolated and allow adults to share and learn from each other's experiences. In addition, a common professional dialogue may be developed to facilitate communication and collaboration among professionals. At Stage Two 104, a formative assessment may be made of the skills and abilities of the adult. During Stage Two 104, an adult preferably is able to determine in which areas they need improvement and then to decide the best course to follow. At Stage Three 106, relevant research and content is gathered to augment the resources available within the discipline. At Stage Four 108, adults are able to share formative feedback with each other. Stage Four 108 may also be a refining process to further sharpen acquired skills and knowledge. At Stage Five 110, development preferably has reached a point where an individual has advanced enough to significantly contribute to the population at large.

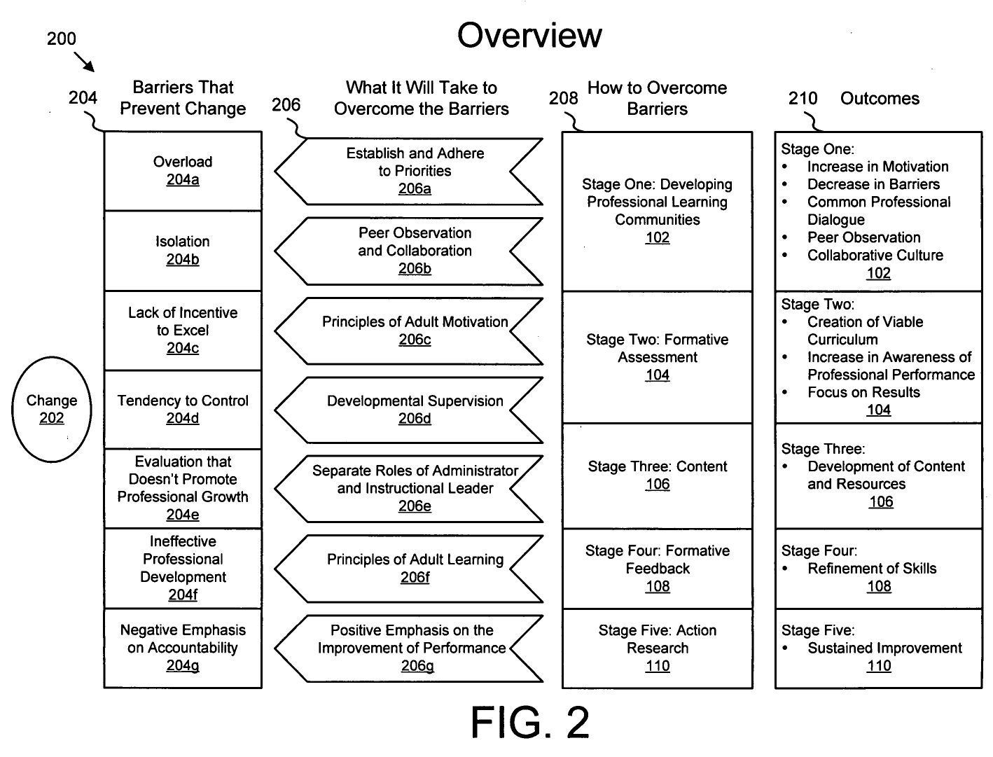

FIG. 2 illustrates in greater detail an overview 200 of an educational development method according to one embodiment of the present invention. Positive change 202 in a current system, such as the educational system, is achieved by overcoming specific barriers 204 that prevent adults from developing to their full potential. A list of corresponding solutions 206 outlines the steps or principles that need to be implemented in order to overcome the barriers 204 that prevent positive change 202. The solutions 206 to cause change may be accomplished in stages 208. Also illustrated are projected outcomes 210 for each stage 208. The stages 208 may be similar to the stages 100 discussed in conjunction with FIG. 1.

The depicted overview 200, in one embodiment, may be designed to assist educators in providing a more effective educational system. The represented example may be adjusted or altered to better accommodate adults in alternative disciplines or situations that experience similar barriers to positive growth. In addition, a computer program may facilitate implementing one or more motivational programs, tracking individual progress, scheduling time, creating workable schedules, creating directive resource material, and the like.

Particularly, the present invention eliminates the barriers 204 to positive change 202—such as overload 204a, isolation 204b, lack of incentive to excel 204c, tendency to control 204d, evaluation that doesn't promote growth 204e, ineffective professional development 204f, negative emphasis on professional accountability 204g, and the like. These barriers 204 are overcome by providing a system that encourages adults to develop a professional learning community (See FIG. 1, Stage One 102).

A professional learning community may comprise one or more groups organized to facilitate peer observation and professional collaboration within a discipline. In one embodiment, a professional learning community may be established by implementing a motivational program, by defining an education facilitator, and by defining a flexible time schedule that allows adults to communicate with each other and learn from each other. The learning communities may help adults effectively overcome many of the barriers 204 that prevent change 202. For example, the learning communities may help adults establish and adhere to priorities 206a to prevent overload 204a. Also, to avoid isolation 204b, adults may participate in peer observation and collaboration 206b within the learning community.

The motivational program may be based on principles of adult motivation 206c and adult learning 206f. Accordingly, adults choose in what areas they want to progress. Preferably, a reward system recognizes the progress achieved. Thus, adults avoid suffering from a lack of incentive to excel 204c and ineffective professional development 204f, which are often a result of professional programs based on tradition or a need for control 204d.

In conjunction with the motivational program, an education facilitator may be chosen to be a motivational leader. The education facilitator may function as a developmental supervisor 206d, yet has a role separate from an administrator 206e. As a result, adults receive supervision that helps eliminate the tendency to control 204d and avoids negative evaluation procedures 204e and negative emphasis on professional accountability 204g that inhibit professional growth. Consequently, adults may feel comfortable seeking assistance for improvement without fearing negative consequences. Ultimately, the present invention provides a positive emphasis on adult improvement 206g that motivates adults to achieve their potential.

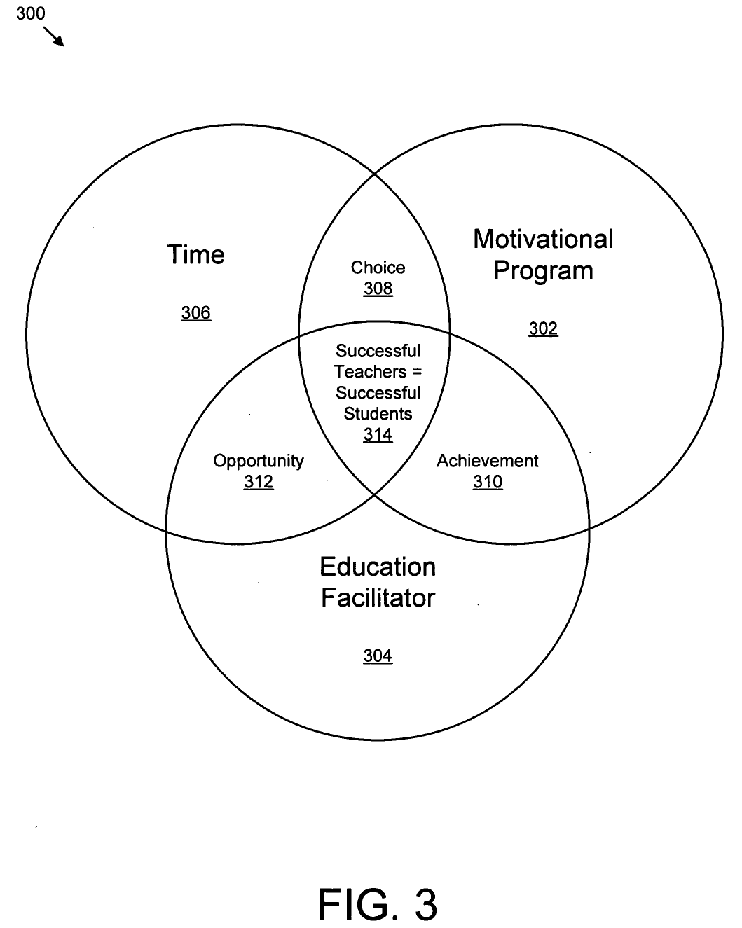

FIG. 3 is a Venn diagram 300 that illustrates three key elements necessary to successfully implement the present invention according to one embodiment. First, a motivational program 302 must be defined and implemented. Secondly, an education facilitator 304, or teacher facilitator in one embodiment, must be defined to administrate the motivational program 302. Thirdly, time 306 must be allotted to allow adults to benefit from the motivational program 302 and the efforts of the education facilitator 304. Principles defined by adult motivation and learning, such as choice 308, achievement 310, and opportunity 312, are fundamental to the success of the present invention. In one embodiment, the projected outcome 314 suggests that teacher success equals student success. In alternative embodiments, professional success may be equivalent to client success, or one adult's success may equal many adults' success, etc. As teachers' attitudes and skills improve, students' attitudes and skills improve as well until a sustained positive environment is created. Skill and professional/personal growth often inspire growth in others.

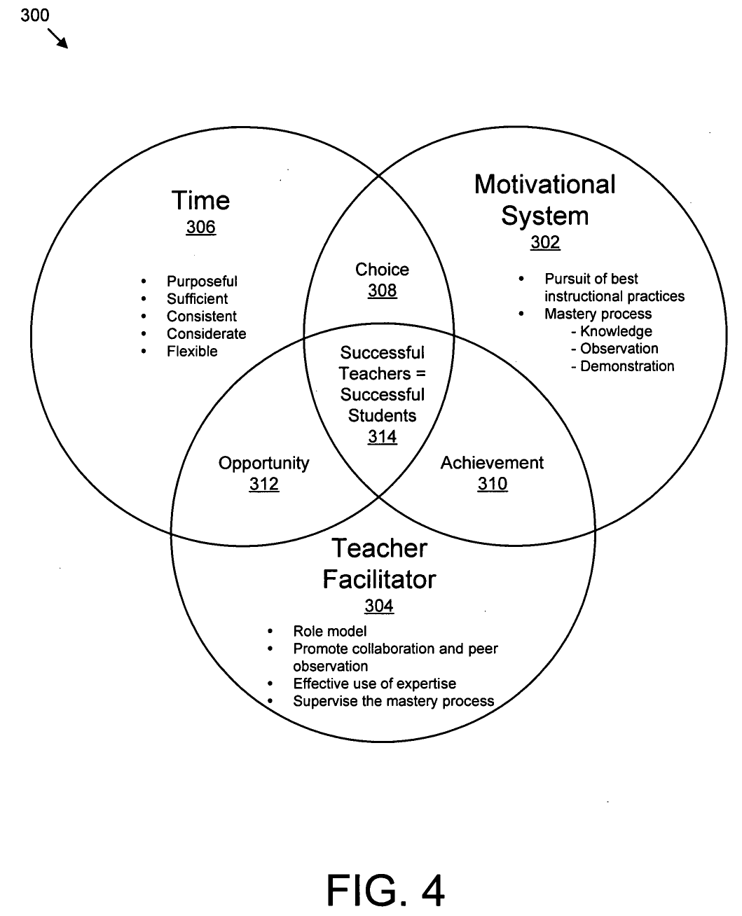

FIG. 4 illustrates in greater detail the functional aspects of each key element 302, 304, 306 discussed in FIG. 3. The key elements 302, 304, 306 in FIG. 4 may illustrate one embodiment of the present invention as designed for implementation in the educational system. The motivational system 302 preferably includes providing the resources for pursuit of best practices. Pursuit of best practice may signify developing an effective knowledge base from current research and accepted practices. One example of forming a knowledge base may comprise evaluating professional approaches, methods, strategies, and the like and combining relevant literature and resources into a collection. Key elements may be isolated and organized into a format that allows adults to choose from a “menu” of practices. In one embodiment, the number of identified practices may be open-ended to encourage adults to identify and implement practices based on personal research and experience.

In one embodiment, a computer program may provide guidelines and organizational structure to facilitate creating a selection of relevant practices. In addition, the program may facilitate learning information about each practice and may include activities to review information and to test knowledge. Consequently, the individual may strengthen their knowledge and continue to explore resources relevant to professional or individual growth. Modern technology, such as databases, online resources, multimedia displays and the like, may facilitate developmental growth.

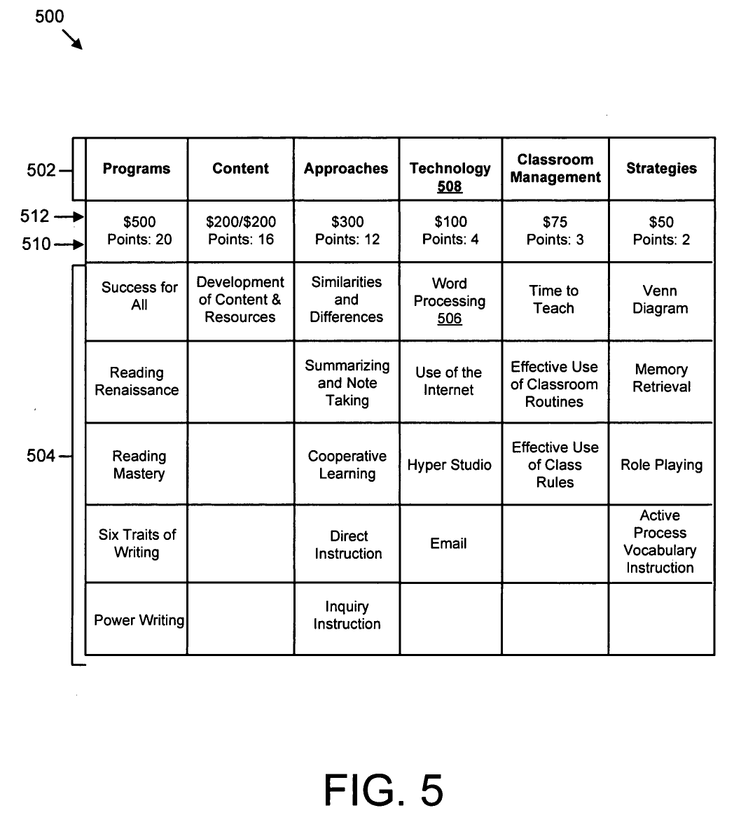

FIG. 5 is a table illustrating one embodiment of effective instructional practices 500 that may be organized into categories 502 and subcategories 504. The listed practices 500 are preferably individualized according to a field of discipline. The practices 500 depicted may be practices 500 typical to the field of education. Each category 502 may be divided into subcategories 504 to facilitate a mastery process. The categories 502 or subcategories 504 may be assigned a point value 510 or a dollar value 512. In view of the motivational program 302 (See FIGS. 3-4), the identified practices 500 themselves may provide an internal motivator to adults for high level learning and personal improvement. On the other hand, the awarded points 510 and/or money 512 may provide an external motivator for adults to receive recognition and benefits for their efforts. Organized practices 500 may also provide a standard of measurement to determine progress and present skill level.

In order to demonstrate mastery of a practice, in certain instances, the individual may be encouraged to gain knowledge about a specific skill or practice, observe someone performing that skill, and then demonstrate the skill with competency. For example, to master word processing 506 under technology 508, a teacher may need to study materials about word processing and using word processors in a classroom. In certain embodiments, a written summary or response may be required to facilitate the learning process. Subsequently, the teacher may be required to observe another teacher using word processors in a classroom. Then, the teacher preferably demonstrates using word processors in a classroom to someone who has achieved mastery in word processing 506.

Once this level of mastery has been achieved, the teacher may continue to learn, observe, and demonstrate the other subcategories 504 designated under technology 508. When all subcategories 504 have been mastered, the teacher may be awarded points 510 and/or money 512 to recognize the teacher's level of achievement. In addition, once an individual accumulates a certain amount of points, that individual may be awarded a permanent pay increase. In a preferred embodiment, peer observation and collaboration encourages individuals to learn from others and to review and practice skills continually.

In certain embodiments, the mastery process may comprise many levels ranging from basic to advanced. When a basic level is mastered, an adult may continue to master skills at a next level, receiving incentives for every level mastered. In one embodiment, adults participating in an advanced level may be encouraged to collect a certain number of examples of a specific practice 502 to demonstrate a profound understanding of the practice 502. Formed study groups or learning communities may facilitate the mastery process. In addition, an education facilitator may determine whether mastery has been achieved. In certain embodiments, the adult may be awarded a permanent pay increase when mastery at a defined level is achieved.

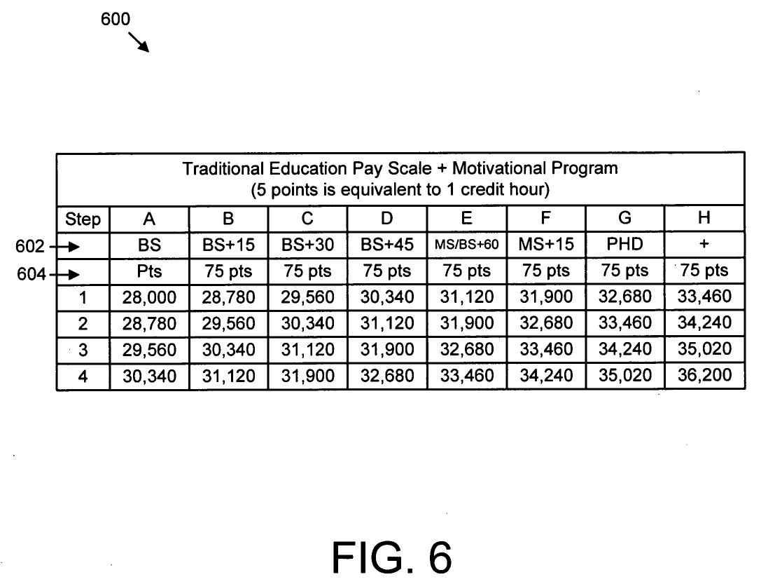

FIG. 6 is a table illustrating one embodiment of a pay scale 600 adjusted to accommodate pay increases awarded for mastery of outlined practices 500 (See FIG. 5). The scale 600 may represent one embodiment of a motivational program 302 (See FIG. 3) to encourage adults to achieve professional development. The pay scale may include traditional advancement 602 based on acquired college credit and mastery advancement 604 based on mastery of instructional practices 500.

In one embodiment, in order to apply the motivational program 302 to the traditional pay scale, accumulation of points 510 (See FIG. 5), or mastery of practices 500, may be similar to completing college credit hours. In one embodiment, five points 510 may be equivalent to one credit hour. Consequently, the pay scale 600 may be advanced accordingly when practices 500 are mastered, or in combination with earned college credit hours. Adults are preferably given the option to receive payment according to an organized motivational program 302 or to accept the traditional pay scale. In a preferred embodiment, adults may advance regardless of their current position on the pay scale.

In certain embodiments, incentives for skills mastery may comprise rewards other than money. Personal time, paid vacations, gift certificates, or the like may also function to recognize adults for their achievement. In addition, motivational programs 302 may vary according to a discipline or according to specific circumstances.

Returning now to FIG. 4, as mentioned previously, opportunity for choice 308 is fundamental to the success of the present invention. Adults decide what they want to learn and how they are going to apply their knowledge. Adults choose the pace at which they want to progress; or retrogress, if they choose. Preferably, non-participants in the motivational system 302 do not receive a negative response from other adults for their decision. Also, adults preferably choose which practices 500 (See FIG. 5) they want to learn, when they will master the practices 500, and how they will be honored once mastery is achieved.

To administrate the motivational system 302, an educational facilitator or teacher facilitator 304, according to one embodiment, is selected. The teacher facilitator 304 is preferably a role model for the other adults participating in the motivational system 302 and demonstrates expertise in a chosen discipline. In the field of education, the teacher facilitator 304 may be another teacher with experience. In other fields, the educational facilitator 304 may be an expert in the field. As a result, the education facilitator 304 may supervise the mastery process as well if needed. In a further embodiment, the education facilitator 304 may be embodied in a computer program. The computer program may provide resources to administrate the motivational program and/or to determine or track skills mastery.

The teacher facilitator 304, in one embodiment, promotes collaboration and peer observation among adults. In one embodiment, the teacher facilitator 304 may do this by organizing a time schedule for adults to discuss, observe, and demonstrate defined practices 500 (See FIG. 5). The facilitator 304 may also arrange to have a substitute fulfill the responsibilities of the adult while the adult is participating in the mastery process.

As discussed previously, the educational facilitator 304 fulfills a role separate from that of a principal or an administrator. The educational facilitator 304, in certain embodiments, is someone to whom adults may go to discuss difficulties, personal concerns, or professional plans without fearing penalty or negative reports. The educational facilitator 304 also ensures that professional development adheres to the principles of adult learning, and that the motivational system 302 leads to effective practice within a discipline. In addition, the educational facilitator 304 may be able to help an individual plan a course of improvement that includes collaboration and peer observation. In one embodiment, the teacher facilitator 304 establishes and/or supervises professional learning communities. Furthermore, a teacher facilitator 304 may utilize specialized software to assist in fulfilling the responsibilities of the education facilitator 304 and for scheduling sufficient time for growth.

Time 306 is an important element fundamental to the success of the present invention. Often institutions require improvements in performance without providing time sufficient for adults to feel that the institution respects their personal time and interests. Many times adults must sacrifice personal time to achieve improved results in performance. The present invention encourages institutions to provide time 306 within a working schedule to allow adults to review their performance and to collaborate with other adults. This allows adults to build positive relationships with their peers as they improve their performance and discuss, observe, and demonstrate instructional practices 500. Adults also build a relationship of trust with the institution because the adults know the institution is looking out for their best interest. Scheduled time 306 should be purposeful, sufficient, consistent, considerate, and flexible.

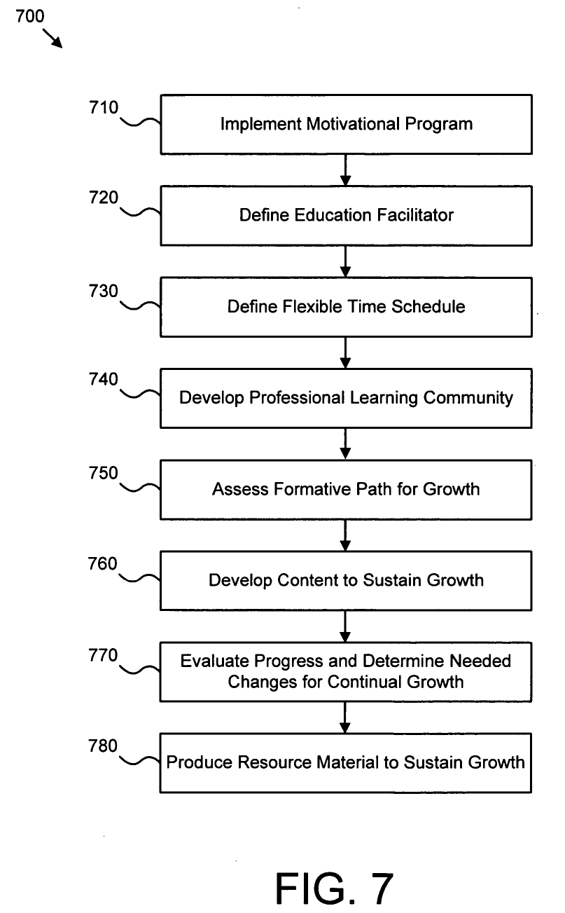

The schematic flow chart diagram illustrated in FIG. 7 is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Additionally, the order in which a particular method occurs may or may not strictly adhere to the order of the corresponding steps shown.

FIG. 7 illustrates one embodiment of an educational development method 700 in accordance with the present invention. As depicted, the educational development method 700 includes the steps of implementing 710 a motivational program, defining 720 an education facilitator, defining 730 a flexible time schedule, developing 740 a professional learning community, assessing 750 a formative path for growth, developing 760 content to sustain growth, evaluating 770 progress and determining needed changes for continual growth, and producing 780 resource material to sustain growth. The steps of the educational development method 700 may be similar to those discussed in relation to FIGS. 1-4.

Referring to FIG. 2, stages 208 of the method 700 may effectively overcome the barriers 204 to change 202, producing positive outcomes 210. By implementing 710 a motivational program, defining 720 an education facilitator, and defining 730 a flexible time schedule, a professional learning community may be developed 740. The professional learning community may increase adult motivation, decrease barriers 204, create a common professional dialogue, and provide a collaborative culture that encourages peer observation, provides resources for adults to solve problems, and enables professionals to focus on the needs of individuals. As adults feel that their basic needs for security and belonging are met, the educational development method 700 encourages pursuit of higher levels of thinking and self-actualization according to theories of human motivation and learning. As a result, adults achieve greater levels of personal satisfaction and professional development.

The pursuit for skills mastery or self-actualization may include assessing 750 a formative path for growth (104), developing 760 content to sustain growth (106), evaluating 770 progress and determining needed changes for continual growth (108), and producing 780 resource material to sustain growth (110). Computer technology may be used to track growth and to organize resources in certain embodiments. As a result, an individual may develop an awareness of professional performance, may focus on changes needed to produce positive results, and may study and practice to refine skills. Consequently, the individual may master skills and may become a positive force within a discipline. In one embodiment, the individual may be encouraged to perform action research and to contribute to the discipline as a whole by increasing the knowledge base and promoting growth in others.

In conclusion, the present invention provides a method for educational development that may be implemented in stages. The present invention may bring about a positive change 202 that influences adult development. Furthermore, the present invention offers a motivational program that provides incentive for adults to advance developmentally.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for educational development comprising:
implementing a motivational program that provides incentive for an adult to pursue skills mastery within a chosen discipline;
defining an education facilitator that assists an adult in pursuing skills mastery within a chosen discipline; and
defining a flexible time schedule that enables an adult to pursue skills mastery within a chosen discipline.

2. The method of claim 1, wherein the education facilitator administrates the motivational program.

3. The method of claim 1, further comprising developing one or more professional learning communities within a chosen discipline.

4. The method of claim 3, wherein a professional learning community comprises one or more groups organized to facilitate peer observation and professional collaboration.

5. The method of claim 3, wherein the education facilitator supervises the one or more professional learning communities.

6. The method of claim 1, wherein the flexible time schedule comprises scheduled time within a full or part-time working schedule.

7. The method of claim 1, wherein the motivational program further comprises:
defining a plurality of practices related to a chosen discipline and dividing the practices into categories and subcategories;
assigning a point value to each category or subcategory;
awarding an adult with the points assigned to each category or subcategory when the adult demonstrates mastery of the corresponding practice; and
increasing the adult's wages when the adult accumulates a defined number of points.

8. The method of claim 7, further comprising assigning a dollar value to each category or subcategory.

9. The method of claim 8, further comprising awarding the adult with the money assigned to each category or subcategory when the adult masters the corresponding practice.

10. The method of claim 7, wherein mastery of a practice comprises:
increasing knowledge about a practice;
observing execution of the practice; and
demonstrating the practice effectively.

11. The method of claim 7, wherein defining a plurality of practices comprises defining practices that correspond to a plurality of skill levels.

12. The method of claim 1, further comprising encouraging participation in the motivational program and respecting individual choice.

13. A method for educational development, the method comprising:
implementing a motivational program that provides incentive for an adult to pursue skills mastery within a chosen discipline;
developing one or more professional learning communities within a chosen discipline;
assessing a formative path for growth within a chosen discipline;
developing content to sustain growth within a chosen discipline; and
evaluating progress and determining needed changes for continual growth.

14. The method of claim 13, further comprising producing resource material relative to a chosen discipline to sustain growth within a chosen discipline.

15. The method of claim 14, wherein the resource material comprises action research.

16. The method of claim 13, wherein the motivational program further comprises:
defining a plurality of practices related to a chosen discipline and dividing the practices into categories and subcategories;
assigning a point value to each category or subcategory;
awarding an adult with the points assigned to each category or subcategory when the adult masters the corresponding practice; and
increasing the adult's wages when the adult accumulates a defined number of points.

17. The method of claim 13, wherein a professional learning community comprises one or more groups organized to facilitate peer observation and professional collaboration.

18. The method of claim 13, further comprising defining an education facilitator that assists an adult in pursuing skills mastery within a chosen discipline.

19. The method of claim 13, further comprising defining a flexible time schedule that enables an adult to pursue skills mastery within a chosen discipline.

20. The method of claim 13, further comprising tracking growth on a computing device.

21. A method for educational development comprising:
implementing a motivational program that provides incentive for an adult to pursue skills mastery within a chosen discipline;
defining an education facilitator that assists an adult in pursuing skills mastery within a chosen discipline;
defining a flexible time schedule that enables an adult to pursue skills mastery within a chosen discipline;
developing one or more professional learning communities within a chosen discipline;
assessing a formative path for growth within a chosen discipline;
developing content to sustain growth within a chosen discipline; and
evaluating progress and determining needed changes for continual growth.
